(19) United States
(12) Patent Application Publication
(10) Pub. No.: US 2025/0173562 A1
(43) Pub. Date: May 29, 2025

(54) SYSTEM AND METHOD OF CREATING INTERPRETABLE LATENT REPRESENTATIONS OF AN ARTIFICIAL INTELLIGENCE MODEL

(71) Applicant: AUTOBRAINS TECHNOLOGIES LTD., Tel Aviv -Yafo (IL)

(72) Inventors: Julius Engelsöy, Tel Aviv-Yafo (IL); Armin Biess, Ness Ziona (IL); Isaac Misri, Tel Aviv-Yafo (IL); Joey Hendry, Tel Aviv-Yafo (IL)

(73) Assignee: AUTOBRAINS TECHNOLOGIES LTD., Tel Aviv -Yafo (IL)

(21) Appl. No.: 18/522,910

(22) Filed: Nov. 29, 2023

(51) Int. Cl. G06N 3/08

(52) U.S. Cl. CPC G06N 3/08

(57) ABSTRACT

A method of training a neural network model based on a latent representation including a human-interpretable data representation necessary for performing a specified task. The method includes obtaining an input data, training the neural network model based on the obtained input data; fixing a gauge function by applying an auxiliary loss function on a latent activation for the specified task, during the training of the neural network model to minimize redundancy, and producing a human-interpretable representation of the latent representation of the neural network model, based on the application of the auxiliary loss function on the latent application.

### FIELD OF DISCLOSURE

The present disclosure relates to the field of computer technology, and more particularly, to a method, non-transitory computer-readable storage medium and computer-implemented system for visualizing a latent representation of a neural network model.

### BACKGROUND

As computing and vehicular technologies continue to evolve, autonomy-related features have become more powerful and widely available, and capable of controlling vehicles in a wider variety of circumstances. For automobiles, for example, the Society of Automotive Engineers (SAE) has established a standard (J3016) that identifies six levels of driving automation from “no automation” to “full automation”. The SAE standard defines Level 0 as “no automation” with full-time performance by the human driver of all aspects of the dynamic driving task, even when enhanced by warning or intervention systems. Level 1 is defined as “driver assistance”, where a vehicle controls steering or acceleration/deceleration (but not both) in at least some driving modes, leaving the operator to perform all remaining aspects of the dynamic driving task. Level 2 is defined as “partial automation”, where the vehicle controls steering and acceleration/deceleration in at least some driving modes, leaving the operator to perform all remaining aspects of the dynamic driving task. Level 3 is defined as “conditional automation”, where, for at least some driving modes, the automated driving system performs all aspects of the dynamic driving task, with the expectation that the human driver will respond appropriately to a request to intervene. Level 4 is defined as “high automation”, where, for only certain conditions, the automated driving system performs all aspects of the dynamic driving task even if a human driver does not respond appropriately to a request to intervene. The certain conditions for Level 4 can be, for example, certain types of roads (e.g., highways) and/or certain geographic areas (e.g., a geofenced metropolitan area which has been adequately mapped). Finally, Level 5 is defined as “full automation”, where a vehicle is capable of operating without operator input under all conditions.

Artificial intelligence (AI) and machine learning techniques have significantly advanced. At the same time, the investigation of the underlying computations in neural networks and/or AI models (hereinafter referred to as models) has grown in importance. Models like Multilayer Perceptrons (MLPs), Convolutional Neural Networks (ConvNets), Recurrent Neural Networks (RNNs), and Transformers have gained widespread recognition for their ability to handle complex tasks and deliver superior performance. One of the challenges that arise with the prevalence of models is how to gain an understanding of the inner workings of these models.

That is, the complexity of models arises from their layered architectures, which may include a multitude of interconnected nodes/neurons and weighted connections. Comprehending the computations within these models during the inference stage is difficult due to these intricate structures. Despite the complexity, understanding these computations may facilitate the interpretation and explanation of the models' reasoning processes, leading to an enhanced level of trust in the models and facilitates their increased adoptions across various domains. Therefore, interests have grown to develop novel techniques and methodologies that unveil the inner workings of these models, bridging the gap between their architectural complexity and the underlying inference reasoning.

Meanwhile, concerns have grown regarding the lack of interpretability and explainability of models, which hinders users' understanding of the decision-making process and their ability to trust and explain model outputs. This lack of model transparency also poses challenges in identifying biases or errors in the models' predictions. Hence, efforts have been invested in transforming “black-box” models into interpretable “white-box” models to address these issues and enable a comprehensive understanding of their internal mechanisms.

However, as the focus on models intensifies, the importance of sophisticated models becomes evident, characterized by a vast number of interconnected neurons and nodes. Consequently, the sheer abundance of neurons within these sophisticated models may lead to distractions, for example, by inadvertently including irrelevant or less significant nodes/neurons when attempting to visualize or provide latent representations of the models to gain interpretability and explainability of the models. The overinclusion of critical neurons and their roles in decision-making undermines the goal of improved interpretability and explainability. Furthermore, the majority of these neurons often contribute little to the model's inference process, resulting in reduced computational efficiency, inefficient resource allocation, and increased energy consumption.

Additionally, the lack of accessible and intuitive interpretability and explainability of models hampers the progressive improvement of model accuracy. Here, accessible and intuitive interpretability and explainability may mean that the visualization of models' latent representations is both computationally manageable from a machine's perspective and easily understandable from a human's perspective. In some cases, the lack of interpretability and explainability in models may allow unnoticed errors and biases to persist, potentially causing significant mistakes and undermining user confidence. This is especially true in systems that are heavily dependent on AI, such as autonomous driving systems where the reliability and fairness of model predictions prioritize. Moreover, poor interpretability and explainability prevent users or developers from conducting post-training improvements on the models, thereby impeding the efficient allocation of limited computational resources, hindering the models' effectiveness in completing tasks and learning from errors, and ultimately impacting their overall accuracy and performance.

Given the aforementioned issues and the increasing integration of AI models into autonomous driving systems, developing algorithms and systems that enhance or improve the interpretability and explainability of these models is of importance. This would aid model developers and users in understanding the decision-making processes of models, ultimately improving system performance. Additionally, it is also important that these algorithms and systems reduce computational costs and associated energy consumption on limited resources while enhancing the inference accuracy across various neural network/AI model types.

### SUMMARY

The present disclosure provides a method, non-transitory computer-readable storage medium and computer-implemented system for training a neural network model as well as visualizing a latent representation of a neural network model.

In a first aspect of the present disclosure, a method of training a neural network model based on a latent representation including a human-interpretable variable/data representation necessary for performing a specified task is provided. The method includes obtaining an input data; training the neural network model based on the obtained input data; fixing a gauge function by applying an auxiliary loss function on a latent activation for the specified task, during the training of the neural network model to minimize redundancy; and producing a human-interpretable representation of the latent representation of the neural network model, based on the application of the auxiliary loss function on the latent application.

In another aspect of the present disclosure, a method of visualizing a latent representation of a neural network model is provided. The method includes obtaining an input data; applying a neural network model trained based on the latent representation including a human-interpretable variable/data representation necessary for performing a specified task, and based on the obtained input data, wherein the neural network has a gauge function that is fixed; producing a human-interpretable representation during inference.

In yet another aspect of the present disclosure, a non-transitory computer-readable storage medium is provided. The non-transitory computer-readable storage medium has stored thereon instructions that, when executed by one or more processors, cause the one or more processors to execute operations. The operations include obtaining an input data; training the neural network model based on the obtained input data; fixing a gauge function by applying an auxiliary loss function on a latent activation for the specified task, during the training of the neural network model to minimize redundancy; and producing a human-interpretable representation of the latent representation of the neural network model, based on the application of the auxiliary loss function on the latent application.

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF DRAWINGS

To illustrate the embodiments of the present disclosure or related art more clearly, the following figures that will be described in conjunction with the exemplary embodiments are briefly introduced. It is obvious that the drawings merely reflect some embodiments of the present disclosure, which means that a person of ordinary skill in the field may obtain other figures according to these figures without creative labor. The arrows in the figures indicate a relationship whereby the component the arrow is pointing to is trained/applied using the component the arrow is pointing from. The embodiments of the disclosure will be understood and appreciated more fully from the following detailed description, taken in conjunction with the drawings in which:

FIG. 1 illustrates a block diagram showing an example of an Artificial Intelligence (AI) model in training, in accordance with some embodiments of the present disclosure.

FIG. 2 is a block diagram illustrating another example of an trained Artificial Intelligence (AI) model in training, in accordance with some embodiments of the present disclosure.

FIG. 3 is a block diagram illustrating another example of an AI model in training, in accordance with some embodiments of the present disclosure.

FIG. 4 is a block diagram illustrating an example of a trained AI model suitable for performing a method for visualizing the model in inference, in accordance with some embodiments of the present disclosure.

FIG. 5 is a flowchart illustrating an exemplary process for producing a human-interpretable representation of the latent representation of a neural network model, in accordance with some embodiments of the present disclosure.

FIG. 6 is a flowchart illustrating an exemplary process for obtaining an auxiliary loss function, in accordance with some embodiments of the present disclosure.

FIG. 7 is a flowchart illustrating another exemplary process for obtaining an auxiliary loss function, in accordance with some embodiments of the present disclosure.

FIG. 8 is a flowchart illustrating an exemplary process for visualizing a latent representation of a neural network, in accordance with some embodiments of the present disclosure.

FIG. 9A depicts a driver's perspective view of a road in an exemplary autonomous driving scenario for a lane-centering task, in accordance with some embodiments of the present disclosure.

FIG. 9B depicts a top-down view of a road in an exemplary autonomous driving scenario for a lane-centering task, in accordance with some embodiments of the present disclosure.

FIG. 10A depicts a driver's perspective view of a road in an exemplary autonomous driving scenario for a distance-keeping task, in accordance with some embodiments of the present disclosure

FIG. 10B depicts a top-down view of a road in an exemplary autonomous driving scenario for a distance-keeping task, in accordance with some embodiments of the present disclosure.

FIG. 11 illustrates an example hardware and software environment for an autonomous vehicle, in accordance with some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Embodiments of the disclosure are described in detail with the technical matters, structural features, achieved objects, and effects with reference to the accompanying drawings as follows. Specifically, the terminologies in the embodiments of the present disclosure are merely for the purpose of describing certain embodiments, but not to limit the disclosure. In the following detailed description, numerous specific details are set forth to provide a thorough understanding of the invention. However, it will be understood by those skilled in the art that the present invention may be practiced without these specific details. In other instances, well-known methods, procedures, and components have not been described in detail so as not to obscure the present invention. The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention. For example, the specification and/or drawings may refer to a processor or to a processing circuitry. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The following specification and/or drawings may refer to an image or an image frame. An image is an example of a media unit. Any reference to an image may be applied mutatis mutandis to a media unit. A media unit may be an example of a Sensed Information Unit (SIU). Any reference to a media unit may be applied mutatis mutandis to any type of natural signal such as but not limited to signal generated by nature, signal representing human behavior, signal representing operations related to the vehicle signals, geodetic signals, geophysical signals, textual signals, numerical signals, time series signals, and the like. Any reference to a media unit may be applied mutatis mutandis to the SIU. The SIU may be of any kind and may be sensed by any type of sensors-such as a visual light camera, an audio sensor, a sensor that may sense infrared, radar imagery, ultrasound, electro-optics, radiography, Light Detection and Ranging (LIDAR), a thermal sensor, a passive sensor, an active sensor, etc. The sensing may include generating samples (e.g., pixel, audio signals, etc.) that represent the signal that is transmitted, or otherwise reach the sensor. The SIU may have one or more images, one or more video clips, textual information regarding the one or more images, text describing kinematic information, and the like.

Any combination of any module or unit listed in any of the figures, any part of the specification and/or any claims may be provided. Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like. The vehicle may be any type of vehicle—for example a ground transportation vehicle, an airborne vehicle, or a water vessel. The vehicle is also referred to as an ego-vehicle. It should be understood that the autonomous driving includes at least partially autonomous (semi-autonomous) driving of a vehicle, which includes all the L2 level types or higher defined in the SAE standard.

As used herein, a neural network or Artificial Intelligence (AI) model, which may be used interchangeably throughout the present disclosure, may be generic or dedicated to a specific application scenario, for example, decision-making, classifications, predictions, etc. In particular, the model may be tailored for regular tasks related to autonomous driving. These tasks may for example be categorized into perception, localization and mapping, planning and decision-making, and control. Perception tasks involve accurate detection and recognition of objects and entities in the surrounding environment. This includes identifying and classifying pedestrians, vehicles, traffic signs, traffic lights, and other relevant objects. Localization tasks focus on determining the precise position of a vehicle in its surroundings which involves utilizing sensors and data to estimate the vehicle's location relative to a known reference point or map, while mapping tasks, on the other hand, involve creating and updating a representation of the surrounding environment. Localization and mapping together enable an autonomous driving system to understand the vehicle's precise location and to navigate it effectively. Planning tasks involve generating a sequence of actions or a trajectory based on the vehicle's current position and desired destination. Decision-making tasks entail analyzing the current driving situation and determining appropriate actions, such as changing lanes, accelerating, braking, or yielding. Planning and decision-making together enable the autonomous driving system to navigate the vehicle in a safer and more efficient manner. Control tasks typically include executing the planned actions and adjusting the vehicle's dynamics to follow a desired trajectory. This includes controlling the steering, acceleration, and braking systems to maintain proper control and stability of the vehicle. Control tasks ensure the vehicle's physical response aligns with the planned actions.

The present disclosure proposes a method for acquiring latent representations within an AI model that are easily interpretable by humans. As explained in more detail below, human-interpretable latent representations may be acquired by learning or fixing a specific gauge function, which minimizes redundancy. In turn, the learning or fixing of a specific gauge function may be accomplished by introducing auxiliary loss functions on the latent activations during training, effectively mandating human-interpretable representations.

As a preliminary matter, in order for the interpretability and explainability of neural networks and/or AI models to be accessible, hundreds, thousands or even millions of neurons within a model are down-scaled so to obtain a simplified and yet relatively compact representation of the whole set of neurons in the model. To some extent, this could facilitate the gaining of an intuitive understanding of which part of the model input each of the limited number of neurons in the relatively compact representation looks at and thus encodes with in order for completing a given task. By simplifying the representation of neurons, a grasp of the neural network's response to a model input under a given task may be achieved.

However, in the attempt to obtain an enhanced or improved interpretable or explainable latent representation of a model for users or other AI-enabled systems, it is desirable to further reduce the number of active neurons. This implies that the mapping relation within the policy head, which serves as an output strategy of the network, needs to be transformed from non-linearity to linearity as much as possible, aiming to achieve the irreducibility of the network. This irreducibility holds significant implications both in the field of computational science and practical applications.

Reducing the number of active neurons helps simplify the computational process and enhances the interpretability and explainability of the model's predictions. By promoting linearity, the mapping relation in the policy head allows for a more straightforward understanding of how the model arrives at its decisions. This shift towards linearization enables a clearer mapping between input features and output reasoning such as predictions, facilitating easier interpretation and explanation of the system's behavior.

It has been recognized that in the context of neural networks and AI models, gauge invariance is an essential concept that relates to the irreducibility and interpretability of the model. Similar to the concept of fixing a gauge in physics, fixing a gauge function in a model may help minimize redundancy and obtain a more compact latent representation of the model, and in particular, a more compact set of active neurons that play an imperative and/or irreplaceable role in the inference of the model, thereby enhancing its interpretability and explainability.

As used herein, the term gauge invariance refers to the symmetry and redundant degrees of freedom present within a model. Taking a simple yet straightforward example in electrostatics, the electric potential Φ may be determined by a transformation where a constant C is arbitrarily applied (i.e., Φ−>Φ+C) due to the independence of the electric field (E=−∇Φ) with respect to the choice of C. In technical terms, the electric field remains gauge-invariant under this transformation of the electric potential. In this regard, the constant C is an inherent redundancy within the electric field system. In terms of some specific applications necessitating the work performed by the electric field system on incoming electrons or those relying on the properties of the electric field system, the constant Cis reducible and serves no substantial purpose in the useful work or practical utilization of the electric field. On the contrary, retaining the constant C or even multiple optional values for C can potentially introduce unnecessary computational overhead in electric field simulations from a machine perspective. Moreover, from a human standpoint, it may incur unnecessary costs in terms of interpretation and/or explanation, which could divert attention away from more relevant aspects.

Thus, considering the concept of gauge invariance, such redundant factors are to be minimized as much as possible during the application of the system. This applies, for instance, in the case of neural networks or AI models, particularly during the inference or, more broadly, prediction processes for which an objective is to maximize the degree of reduction in the mapping relation between inputs and outputs, thereby enhancing the model's interpretability or explainability. One possible approach involves transforming the model's policy head to be more linear by fixing a gauge function (i.e., achieving gauge invariance), rather than retaining numerous reducible and nonlinear redundant factors such as abundant less relevant neurons and the associated connection weights. The transformation of the model's policy head to be more linear via the fixing of gauge function facilitates clearer interpretation and understanding of the model as compared to the case where the gauge varies due to a nonlinear, reducible mapping relation within the policy head carrying numerous redundant elements of the model.

The present disclosure proposes a method for training a neural network model. The trained model is expected to enhance the interpretability or explainability of the trained model during the inference stage. In addition to providing model inference outputs for tasks such as autonomous driving, the method aims to provide an enhanced latent representation of the model's inference process. To do so, a gauge function of the model is to be fixed by applying an auxiliary loss function such that the policy head, which entails the model's decision-making, exhibits a more linear characteristic and reduces the number of active neurons/nodes in the model's original latent representation. In doing so, redundant factors involved in the model's inference process are removed from the latent representation to a large extent. With such an enhancement, the input-output mapping relation of the model, which is typically embodied by policy head of the model, transforms to become more linear than when no auxiliary loss function is applied.

Additionally, the application of the auxiliary loss function to arrive at the learned or fixed gauge function may serve as a reference point, marker, or basis for interpretation and explanation of models. Also, fixing the gauge can further reduce the number of active neurons in the relative compact representation of the whole set of neurons within a model. With the number of active neurons/nodes in the model's original latent representation reduced, and redundant factors involved in the model's inference process as manifested in the latent representation removed, the resulting model requires less time and less computational resources during inference stage. Hence, the model's inference becomes not only task-oriented but also more interpretable, explainable, and computationally efficient. This results in a more concise and intuitive latent representation of the model, which enhances its interpretability and explainability to both human and other systems that are AI-enabled.

Accordingly, users, model developers, or the trained model can modify and/or fine-tune the network structure of the previously trained AI model for a given task based on the generated enhanced latent representation, such as deactivating or even removing those nodes that are less relevant to the model's decision-making due to the countable number of reduced neurons. The deactivation or removal of less relevant nodes save computing resources, simplifies the model's decision making process, and increase computational efficiency. Additionally, by using the enhanced latent representation generated by the method and system disclosed in the present application, model developers or AI-enabled systems can review whether it is necessary to modify the type, quantity, format, etc. of the model input to better facilitate the generation of correct model decisions. As such the enhanced latent representation may improve the accuracy of the model inference for the model input in the given task, and enhance the safety and reliability of using such AI models in applications such as autonomous driving systems.

Moreover, with increased human interpretability of the AI model, the user and/or trainer may provide more accurate feedback to the model as reference data. Such higher quality of reference data reduces the overall amount of data required for the model to achieve task-specific purposes. This means that the model requires less time and less computational resources to train its parameters to achieve a working model.

It should be noted that the flexibility of the disclosed method is a notable feature as it does not depend on the specific intricacies or implementation details of the model. Consequently, it can be effectively applied to a wide range of models, regardless of their architecture, size, or complexity. The scalability ensures its compatibility with various types of models, including neural networks, deep learning models, reinforcement learning models, or any other form of machine learning algorithms. Overall, the disclosed method provides a resource-efficient and scalable approach to gain enhanced and yet straightforward insights into a model by utilizing an auxiliary loss to fix a gauge function of the model while alleviating increased computational resources for model inference and avoiding dependence on model-specific details, ensuring compatibility across various types of models, and in turn making it valuable in practical applications.

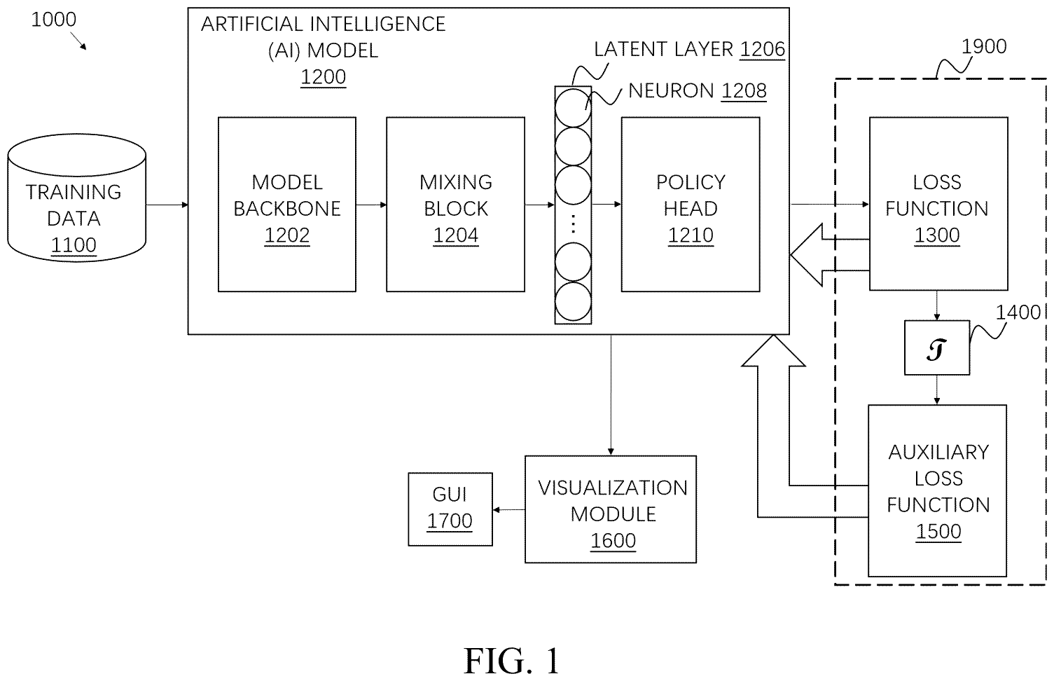

Now referring to the drawings, wherein like numbers denote like parts throughout the figures. FIG. 1 illustrates a block diagram 1000 showing an example of an Artificial Intelligence (AI) model in training, in accordance with some embodiments of the present disclosure. As shown in FIG. 1, an AI model 1200 may include a model backbone 1202, a mixing block 1204, a latent layer 1206, a plurality of neurons 1208, and a policy head 1210 within the latent layer 1206.

The model backbone 1202 may constitute a foundational part of the AI model 1200, which may for example be responsible for initial data processing. In some examples, the model backbone 1202 may include various layers and modules designed to extract and transform information carried in model inputs, which are provided by training data 1100 during a training stage. The model backbone 1202 captures, extracts, and classifies the essential features and representations from a large number of model inputs (e.g., frontal images or videos of a road, or annotations of lateral acceleration, etc.), which need subsequent analysis and decision-making within the AI model 1200. In an embodiment, the model backbone 1202 may be a Convolutional Neural Network (CNN) that learns different features such as lines and curves of a road.

The mixing block 1204 may, for example, integrate and combine information from different parts (e.g., layers) of the model backbone 1202. It enhances the overall representation of the input data by facilitating the exchange of information and feature fusion amongst the model inputs. The mixing block 1204 ensures the effective sharing and utilization of relevant information, improving overall performance and accuracy of the AI model 1200. In an embodiment, the mixing block 1204 may be a Multi-Layer Perceptron (MLP), which may include channel-mixing MLPs that allow communication between different channels, and/or token-mixing MLPs that allow communication between different spatial locations. These layers may be interleaved (i.e., combined) to enable interaction of both types of inputs.

The latent layer 1206 may contribute to a simplified and yet relatively compressed representation of the model inputs (which may for example be the training data 1100 during the training stage), and such representation may explicitly or implicitly include a summary of key features about the model inputs, such as features related to lane boundaries. In some embodiments, the latent layer 1206 may be obtained by dropping duplicated or extraneous elements (e.g., neurons or nodes) using different data representation and approximation techniques. This allows for transferring fewer data without substantial losses and transferring a simplified version of the model instead of a gigantic ontology model. As such, computational efficiency may be improved, as less data needs to be processed and transferred from one area to another. Also, with barely no losses, model accuracy may be maintained.

The latent layer 1206 may include multiple neurons 1208, with each neuron dedicated to or focused on capturing and processing specific input features or patterns for a given task. In some examples, the latent layer 1206 may serve as a relatively compact version of neurons representing a whole set of neurons within the AI model. That is, the number of neurons in the latent layer 1206 is limited compared with the original number of hundreds, thousands or even millions of neurons within the intricate structure of the model 1200. Consequently, the collective behavior of these neurons 1208 may contribute to the holistic processing of the input data within the AI model 1200 in order for the task to be completed.

The policy head 1210 represents a component that develops a strategy and generates a final output or implementation decision based on an analysis of the processed input data. The policy head 1210 also provides a higher-level understanding of the model inputs. That is, the policy head 1210 dictates the action(s) to be taken, based on the state of the model 1200 and the surrounding environment that is detected. In an embodiment, the policy head 1210 may be a trainable AI model.

During a training stage, the AI model 1200 receives, processes the model inputs from the training data 1100, and generates model outputs such as action(s) to be taken under a given task, which outputs are to be compared with a set of ground truths within a loss function module 1300. An example of the model inputs may be an image signal depicting a frontal view images of the road. However, those of ordinary skills in the field may understand that there may also be other suitable forms of training data, such as audio signals, text annotations or a combination of audio and image signals (e.g., video streams) along with text annotations. In some embodiments, the model inputs may be raw data from one or more sensors of a same or a separate vehicle. For example, the model inputs may be an image captured by a camera sensor that includes Red-Green-Blue (RGB) value of pixels. The model inputs may be a raw SIU, a processed SIU, text information, information derived from the SIU, and the like. In different embodiments, the loading of the model inputs may be from a local disk, over a suitable “cloud” network, from a remote storage location, etc. Obtaining of the model inputs may include receiving the data, participating in a pre-processing of the data, pre-processing only a part of the data and/or receiving only another part of the data, and generating the pre-processed data, etc. The processing of the model inputs may include at least one out of detection, noise reduction, improvement of signal to noise ratio, defining bounding boxes, and the like. The model inputs may be received from one or more sources such as one or more sensors, one or more communication units, one or more memory units, one or more image processors, and the like.

From the received model inputs (for example, the training data 1100 during the training stage), the model backbone 1202 may extract features that are useful for performing the task, such as the curvature of the road that is included in the image, lane markers, etc., and may pass the extracted features to the mixing block 1204. Here, the features are combined, reduced from high dimensional model input data into a low dimensional latent vector, and fed into the latent layer 1206 that is manifested as a relatively compact set of neurons as mentioned above. In such a manner, the data volume or the complexity of data flows may be reduced when arriving in the latent layer 1206, as the whole set of neurons of the AI model 1200 is compressed. Such compression further improves computational efficiency, as less data mappings would need to be learned and processed.

The latent layer 1206 helps to learn data characteristics and thus simplify data representations. These data characteristics may then be stored within individual neurons 1208. The policy head 1210 processes the information received from the latent layer 1206, which may, for example, include environmental information for performing the task such as the curvature of the road, lane markers, and additionally the current positions of a vehicle relative to the road, its current speed and lateral acceleration, whether there are other vehicles nearby, etc. The information from the latent layer 1206 may also include information regarding the latent layer per se such as the reduced number of the neurons within the latent layer 1206 representing the whole set of neurons of the intricate model structure. The policy head 1210 outputs some model outputs according to the processed information. In an embodiment, a model output may include an output driving operation decision such as an instruction or action to turn a steering wheel, in order to increase lateral acceleration and keep the vehicle centered within a curving lane.

In some embodiments, the model backbone 1202 and the mixing block 1204 may be configured to map the model inputs into the latent layer 1206, according to some criteria that may be stored in a database of semantic relations. In some embodiments, the model backbone 1202 learns the input data dimension compression to encode the features' latent representation, whereas the policy head 1210 recreates the encoded latent representation to a reconstructed output such as the model output. For example, the model backbone 1202 may be configured to generate compressed latent layer 1206 of the model input with a one-dimensional vector, representing one or more elements of the model input. In one embodiment, the compressed latent layer 1206 may be expressed as a vector V, wherein V=[E1, E2, E3, . . . . EN], where E1 means element 1, E2 means element 2, E3 means element 3, and EN means element N. Each element may be a single or plural dimensional matrix. Each element may represent a potentially useful feature of the surroundings of the vehicle, such as lane borderlines, lane centerline, vehicles nearby, traffic signs, tree contours, etc.

The model backbone 1202 may be configured to encode meaningful information about various data attributes in its latent manifold which can then be exploited to carry out pertinent tasks. In such embodiments, the latent layer 1206 helps to reduce the dimensionality of the input data and to eliminate non-relevant information. Thus, the dimensionality reduction of the input data may reduce computational consumption, as less computer resources need to be allocated to process the reduced complexity and volume of the input data. Also, model accuracy may be improved, as irrelevant information that may skew the modelling are eliminated.

In some embodiments, given the latent layer 1206, the policy head 1210 may be configured to determine the behavior that a vehicle needs to follow from a set of predefined tasks. The tasks determine the actions that an autonomous car needs to take. Some examples of these tasks are lane-centering, distance-keeping, overtaking another car, changing lanes, intersection handling, and traffic light handling, among others.

The model output from the AI model 1200 (e.g., from the policy head 1210) may represent an action to be performed in the context of a specific application scenario such as autonomous driving, for instance, manipulation of the gas pedal, brake pedal, or the steering wheel, etc. Although the depicted components in FIG. 1 are shown to constitute an AI model, it is readily appreciated that other AI models tailored for specific application scenarios (e.g., decision-making, autonomous driving, etc.) can also be generalized as including similar components as shown in FIG. 1.

Within the AI model 1200, the loss function, for example shown as the loss function block 1300 in FIG. 1, plays an important role during the training stage of the AI model 1200. The loss function 1300 may be configured to assess the disparity between the model's predictions, given by the policy head 1210 of AI model 1200, and the actual values, provided as ground truth values a priori. By measuring this difference, the loss function 1300 may quantify the AI model's performance, enabling it to optimize its learning process and enhance its predictive capabilities.

A primary objective of the loss function 1300 is to minimize the discrepancy between the model's outputs and the ground truth values. It serves as a guide for the model to adjust its internal parameters and update the weights in order to minimize the overall loss. This process is typically accomplished through various optimization algorithms, including gradient descent, which iteratively updates the model based on the calculated loss. Hence, the loss function 1300 may act as a crucial feedback mechanism during the training stage. By evaluating the model's performance, it provides valuable information on the direction and magnitude of necessary changes to improve predictions. By minimizing the loss in an iterative basis for example, the AI model 1200 becomes more adept at capturing the underlying patterns and relations within the training data 1100.

As depicted in FIG. 1 and subsequent figures, the thicker arrows represent the backpropagation of errors generated by various types of loss functions towards the network architecture of the AI model.

The choice of the specific loss function, such as mean squared error or cross-entropy, depends on the particular task and characteristics of the AI model 1200. These functions measure the dissimilarity between model's predicted outputs and ground truth values in different ways, allowing for customized optimization based on the specific problem domain. By virtue of the loss function 1300, the AI model 1200 may learn from the provided feedback, adjust internal parameters, and enhance its predictive capabilities in line with the task at hand.

However, when considering the need to fix the gauge function of the AI model 1200, the current loss function module 1300 alone is insufficient because it may be unable to linearize the policy head or improve the reducibility of the model. Therefore, an auxiliary loss function according to embodiments of the present disclosure is introduced, for example, as shown at block 1500. The auxiliary loss function 1500 aims to further reduce the number of neurons/nodes present in the original latent representation of the AI model 1200, making it truly interpretable and explainable for both humans and machines. This approach eliminates the need for allocating attention or computational resources to irrelevant neurons/nodes and their associated connections in the latent representation from a human standpoint or a machine perspective. The auxiliary loss function 1500 helps in removing redundancy and simplifying the mapping relations within the model, making it more interpretable and understandable both for humans and machines.

In some embodiments, the auxiliary loss function can be derived from certain transformation(s) applied to the original loss function 1300, as indicated by the transformation block 1400 shown in FIG. 1. The transformation, represented by a block 1400, receives information from the loss function 1300, including its function form, and performs operation(s) to transform it before forwarding the transformed function to the auxiliary loss function 1500. It is to note that the information received by the block 1400 from the loss function 1300 may also include the model's predicted outputs given by the policy head 1210 and provided to the loss function 1300, though the block 1400 itself does not perform any transformations on the model's predictions. The transformations performed by the block 1400, such as function transformations, may for example but not limited to common approaches such as first-order or second-order differentials.

In some embodiments, the auxiliary loss function may be obtained as follows. Firstly, a loss quantity may be determined. In some examples, the loss quantity may define a non-linearity of a policy head of an AI model for the specified task which the AI model performs during the training stage. In some examples, the loss quantity may manifest as the original loss function that is relied upon during the training stage of the AI model. Then, a first derivative of the determined loss quantity may be obtained to determine the non-linearity of the policy head. In some example, instead of obtaining the first derivative, a second derivative of the determined loss quantity may be obtained to minimize the non-linearity of the policy head. The choice of the order of derivative may depend at least in part on the task that the AI model performs, the properties of the (original) loss function, the degree to which the irreducibility of the AI model is to be achieved, or the like. Optionally, an absolute value of the obtained derivative, either first or second derivative or the like, may be taken as an absolute value function to be added back into policy head during training to minimize loss for the specific task, and so as to reduce computational complexity and thus save computational resources. The resulting function, for example, the derivative function and/or the absolute value function, may serve as the auxiliary loss function to be minimized along with the loss function. In some examples, the derivative function and/or the absolute value function may be added to the latent activation during the training. The latent activation may in some cases refer to the original loss function that is associated with the model's latent layer and its functioning. Thus, the latent variables that ended up in the enhanced latent representation may have a simple relation (for example, approximately linear relation) to the actual outputs/actions that the AI model suggests.

In some embodiments, both the loss function 1300 and the auxiliary loss function 1500 may independently store the ground truth values corresponding to the training data 100. Alternatively, the ground truth values may be passed along with the information provided by the loss function 1300 to the block 1400 for further transmission to the auxiliary loss function 1500. In this case, the ground truth values are not processed by the block 1400. That is, apart from the information related to the function form of the loss function 1300, the block 1400 may be transparent to other information such as the model's predicted outputs or ground truth values.

The joint cooperation between the loss function 1300, the transformation 1400 and the auxiliary loss function 1500, as indicated by reference numeral 1900, allows for a more flexible and versatile approach to fixing the gauge of the AI model 1200 and thus optimizing the model. By transforming the original loss function 1300, the auxiliary loss function 1500 can capture additional patterns or relationships within the latent representation of the model, leading to further enhancements in model interpretability and resource allocation. This facilitates a more focused utilization of computational resources, reducing any unnecessary complexity introduced by irrelevant elements (e.g., neuron/nodes and associated weighted connections) within the model. By leveraging the transformation capabilities of the transformation block 1400, the auxiliary loss function 1500 contributes to the overall improvement of the model's interpretability and its ability to deliver meaningful and yet straightforward insights for both human understanding and machine-based decision-making processes.

In some embodiments, a method of training a neural network model based on a latent representation including a human-interpretable variable/data representation necessary for performing a specified task is provided. The method includes obtaining an input data; training the neural network model based on the obtained input data; fixing a gauge function by applying an auxiliary loss function on a latent activation for the specified task, during the training of the neural network model to minimize redundancy; and producing a human-interpretable representation of the latent representation of the neural network model, based on the application of the auxiliary loss function on the latent application. By leveraging the concept of gauge invariance through fixing a gauge function, a desired irreducibility in the model may be achieved, resulting in a more interpretable and explainable representation characterized by a minimal number of active neurons. This approach enables a more intuitive understanding of the model's behavior and enhances its practical applicability in various domains. The reduction of redundancies and complexities in the neural network enhances its transparency, making it easier to interpret the decision-making process. This achieved enhanced interpretability allows researchers to optimize model inference performance by reallocating limited computational resources to a manageable number of active neurons, from a human perspective.

In some embodiments, the exemplary training process 1000 may also include a visualization module 1600 to present the enhanced latent representation of the AI model resulting from the introduction of the auxiliary loss function 1500. Additionally, the graphical outputs from the visualization module 1600 may be displayed via a GUI module 1700. This enables a comparison between the latent representations without the auxiliary loss function and the enhanced latent representations with auxiliary loss function, thereby aiding in the improvement of the model performance and interpretability during the training phase.

In particular, the visualization module 1600 may be useful in providing visual representations of the model's latent features by enabling researchers including developers and users to observe the changes and improvements in the model's interpretability and reducibility brought about by the incorporation of the auxiliary loss function. By comparing the latent representations before and after including the auxiliary loss function 1500, one can identify improvements and gain insights into the model's learning and decision-making processes. The graphical outputs from the visualization module 1600, displayed through the GUI module 1700, allow users to comprehend the impact of auxiliary loss functions on the model's latent representation and support informed decision-making during the training process.

This visual feedback loop empowers researchers to gain an intuitive understanding of how the black-box model works under a given task and potentially make informed decisions regarding the effectiveness of auxiliary loss functions, thereby aiding in continuous improvements of the model's training.

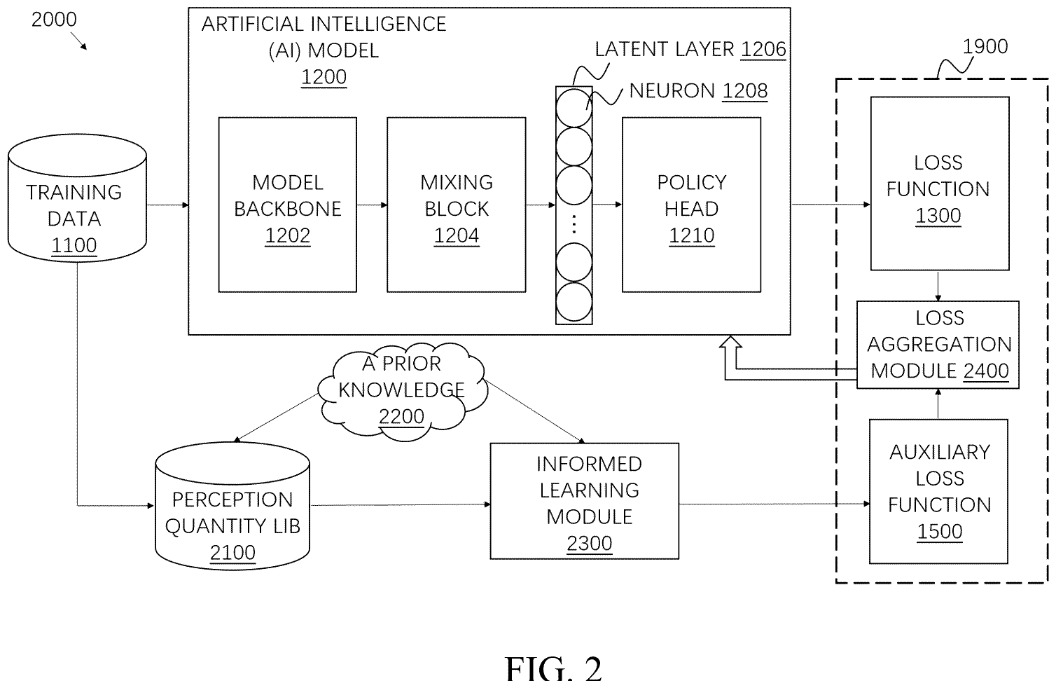

FIG. 2 is a block diagram 2000 illustrating another example of an trained Artificial Intelligence (AI) model in training, in accordance with some embodiments of the present disclosure. In FIG. 2, similar to the previous figure, the same elements are denoted by the corresponding reference numerals and, therefore, are not further described herein. The main difference between FIG. 1 and FIG. 2 lies in that, in the exemplary block diagram 2000, informed learning techniques in the field of AI are employed to construct the auxiliary loss function, instead of relying on transformation(s) of the original loss function that is intended to calculate losses between predictions and ground truths.

Informed learning, also known as knowledge-based learning, refers to the utilization of domain-specific knowledge and/or task-specific information to enhance the learning process of an AI model. By incorporating informed learning, the AI model 1200 may benefit from the expertise and/or prior knowledge of domain specialists, which encapsulates specific features and constraints of the task at hand. This prior knowledge may take various forms and be integrated into the design of auxiliary loss function to guide the learning/training process of the model. For instance, domain expertise can be embodied as a priori distributions, model constraints, or weights on the loss functions, aiming to improve the model's performance on the specific task.

As shown in FIG. 2, a perception quantity library 2100 may obtain and store therein a dataset related to a given task of the training stage from the training data 1100. In an example, each part of the training data 1100 in the obtained dataset may include physical quantities relevant to the task. In another example, each part of the training data 1100 in the obtained dataset may be processed to obtain or may assist in obtaining physical quantities relevant to the task. Then, based on some indication(s) provided by a prior knowledge 2200, the perception quantity library 2100 passes a subset of its stored dataset to an informed learning module 2300. In an example, each element in the subset may be a relevant physical quantity selected from the perception quantity library 2100 under the guidance of the prior knowledge 2200 for comparison with the variables occurring in the latent representation of the AI model 1200.

The informed learning module 2300 may be configured to process the input (i.e., the subset described above) from the perception quantity library 2100 based on the knowledge stored thereon and associated with a generic task or a specific task (or a series of tasks), such as filtering the input to select a portion thereof consistent with its informed knowledge, processing the input to obtain a portion thereof consistent with its informed knowledge, classifying the input to obtain multiple clusters consistent with the informed knowledge, or the like.

Upon receiving the subset provided by the perception quantity library 2100, the informed learning module 2300 may pass the information required for constructing an appropriate auxiliary loss function to the auxiliary loss function 1500 based on the knowledge stored thereon. Additionally, upon receiving the subset, the informed learning module 2300 may provide information required for constructing auxiliary loss function as needed to the auxiliary loss function 1500 based on the knowledge stored thereon in combination with additional knowledge provided by the prior knowledge 2200.

In some embodiments, the auxiliary loss function may be obtained via informed learning as follows. First, a family of related/predetermined variables may be received. In some examples, the family of related/predetermined variables may be needed for the policy head 1210 to conduct a latent activation for a specific task together with input data. Then, a distance between a combination of the family of related variables and a latent representation associated with the family of the related variables may be obtained. The obtained distance may be added to a loss function to train the policy head 1210 and the latent representation, and encourage the informed learning. In some examples, the above distance may be any of distance metrics that are commonly used to quantify the similarity or dissimilarity between data points or representations in neural networks or AI models, such as Euclidean Distance, Manhattan Distance, Cosine Similarity, Hamming Distance, Jaccard Distance, etc.

Once an appropriate auxiliary loss function is constructed, it can be aggregated with the main/original loss function to form a composite loss function, where the aggregation may be performed at loss aggregation module shown as block 2400. This composite loss function not only minimizes the discrepancy between model predictions and ground truth for backpropagation through the layers of the model's network architecture during the training phase, but also aims to reduce the model's latent representation as much as possible to obtain an intuitive and human-interpretable representation.

By combining the auxiliary loss function with the main loss function, the neural network can be optimized not only for more accurate predictions less prone to errors that make them unsafe, but also for improved transparency. This allows researchers to gain additional insights into the decision-making process whenever the auxiliary loss function is applied to see which features the model deems as important in the model's decision, and interpret the model's behaviors in a more intuitive manner. Ultimately, this aggregation of losses enables the model to learn representations that are not only effective but also easier for humans to understand and interpret. This leads to simplification more efficient allocation of the limited computational resources that also reduce energy consumption by the computational resources to perform unnecessary tasks.

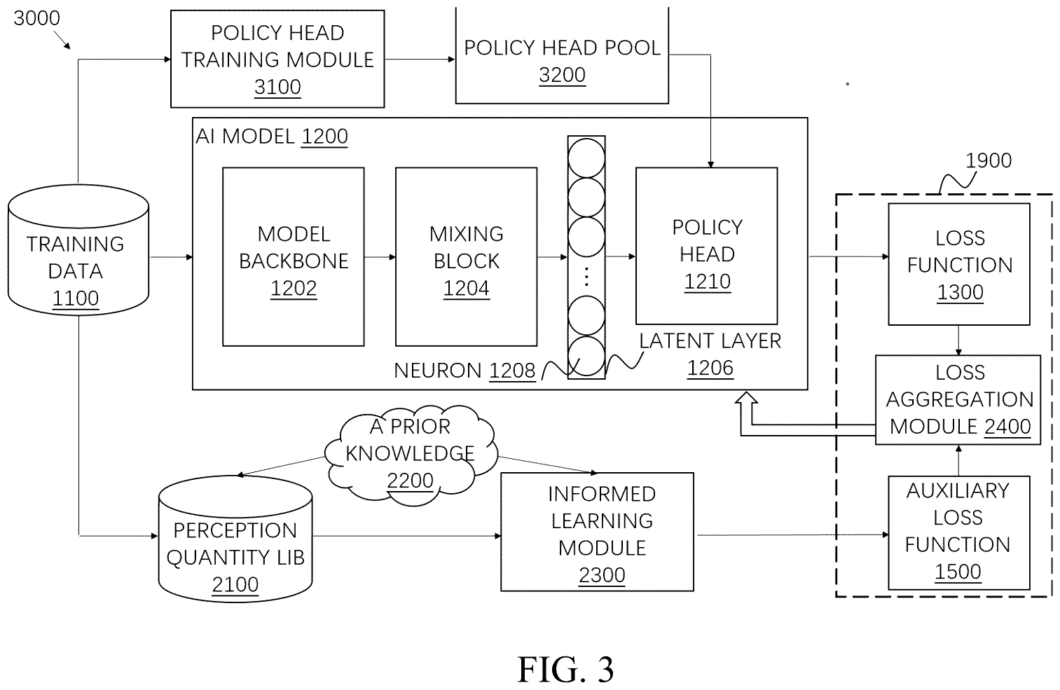

FIG. 3 is a block diagram 3000 illustrating another example of an AI model in training, in accordance with some embodiments of the present disclosure. In FIG. 3, similar to the previous figures, the same elements are denoted by the corresponding reference numerals and, therefore, are not further described herein. The main difference between FIG. 2 and FIG. 3 lies in that the exemplary block diagram 3000 additionally includes a policy head training module 3100 and a policy head pool 3200. The policy head training module 3100 obtains data for training the policy head from the training data 1100. Once trained, the policy heads are fed into the policy head pool 3200. Based on the task type during the AI model training stage, an appropriate policy head from the policy head pool 3200 is selected and provided to the policy head 1210 in the AI model 1200.

Thus, the model training process is enhanced by incorporating a dedicated module for training the policy head and a pool of policy heads with different training strategies. The policy head training module 3100 adjusts the policy head parameters using the training data, while the policy head pool 3200 provides flexibility in selecting the most suitable policy head for the AI model based on the task type and/or input data characteristics.

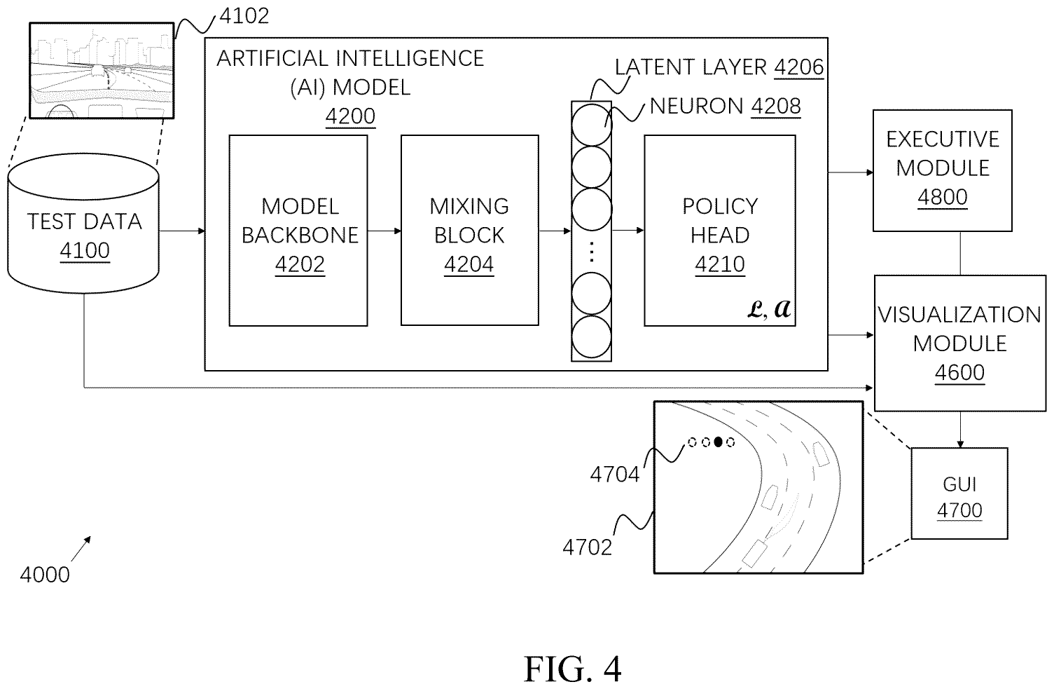

FIG. 4 is a block diagram illustrating an example of a trained AI model suitable for performing a method for visualizing the model in inference, in accordance with some embodiments of the present disclosure. As shown in FIG. 4, an AI model 4200 may include a model backbone 4202, a mixing block 4204, a policy head 4210, a latent layer 4206, and a plurality of neurons 4208 within the latent layer 4206. Note that one of the main differences between FIG. 4 and any of FIGS. 1 to 3 is that the process depicted in FIG. 4 represents the inference stage of the AI model. At this stage, the AI model 4200 has completed its training, and the connections of its internal components and weights thereof have been determined and affixed. It should also be noted that the bottom-right corner of the policy head module 4210 is labeled with italicized L and a, indicating that the policy head 4210 undergoes backpropagation of errors generated by both the loss function L and the auxiliary loss function a. As a result, the optimization of the policy head is influenced by these two loss functions. Additionally, the auxiliary loss function a can be any of the aforementioned auxiliary loss functions described above or their variants.

The AI model 4200 receives test data 4100 as input and provides its output(s) to a visualization module 4600 and an executive module 4800. The output(s) of the executive module 4800 (not shown) may be used to manipulate the mechanical, electronic, or electromechanical modules, devices, components, and equipment of a vehicle to achieve autonomous driving functionality for a given task. These two modules, 4600 and 4800, may be communicatively connected to better achieve the objectives of the AI model's inference stage. The output of the visualization module 4600 may be provided to the GUI module 4700 to visually present the enhanced latent representations as described in the present disclosure to the user.

An illustrative representation of the test data 4100 is thumbnail 4102. The thumbnail 4102 captures a road image frame from the driver's perspective, encompassing features such as lanes, moving vehicles, and the distant city skyline. This thumbnail 4102 can be either the raw image frames or video sequences captured by the vehicle's sensors, such as camera(s), or they can be preprocessed with various image processing operations.

Also, one illustrative representation of the enhanced latent representation, presented by the GUI module 4700, is thumbnail 4702. The thumbnail 4702 incorporates several non-reducible neurons 4704 (depicted as four neurons, merely for exemplary purposes and not construed to be limiting), which are obtained by utilizing an auxiliary loss function, in conjunction with the original loss function of the AI model, to fix the gauge of the AI model and reduce the neural ensemble contained in the original latent representation. As a result, the input/output mapping of the policy head entailed by the enhanced latent representation tends towards linearity, minimizing the involvement of redundant factors in the model's decision-making process. This leads to improved interpretability of the AI model, for example, by inspection of the displayed enhanced latent representation such as exemplary thumbnail 4702.

As shown in thumbnail 4702, one neuron is represented as a black dot, while the other three neurons are represented as white dots. This may for example indicate that the current task of the AI model is significantly related to the neuron represented by the black dot. In other words, this neuron may play a crucial role in efficiently encoding the information payload related to the model's control output within the input image frame.

The enhanced latent representation can adopt various GUI arrangements, and the present disclosure does not impose any limitations on this. The exemplary thumbnail representations used are for illustrative purposes only, and the interpretation of the relationship between neurons and tasks should be based on the specific context and model architecture.

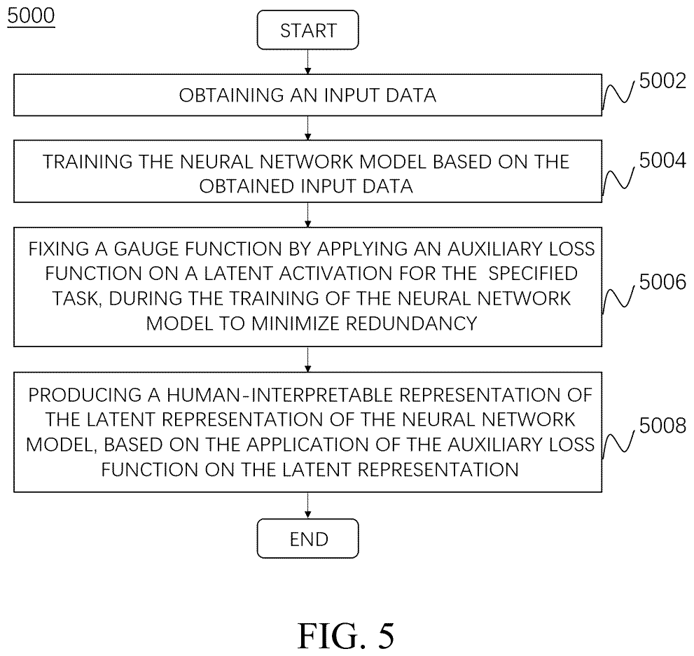

Now turning to FIGS. 5-8, these figures illustrate methods 5000, 6000, 7000 and 8000 corresponding to the method and models as discussed above that may be used to train an AI model, to obtain an auxiliary loss function and to visualizing a latent representation of an AI model. Here, the sequences of steps described in the methods 5000, 6000, 7000 and 8000 are exemplary and indicate no order of the steps that the methods 5000, 6000, 7000 and 8000 are to be performed.

Referring to FIG. 5, in some embodiments, a method 5000 of for producing a human-interpretable representation of the latent representation of a neural network model necessary for performing a specified task is provided. The method 5000 starts at 5002, where an input data is obtained. Then, at 5004, the neural network model is trained based on the obtained input data. Thereafter, at 5006, a gauge function is fixed by applying an auxiliary loss function on a latent activation for the specified task, during the training of the neural network model to minimize redundancy. Finally, at 5008, a human-interpretable representation of the latent representation of the neural network model is produced based on the application of the auxiliary loss function on the latent application.

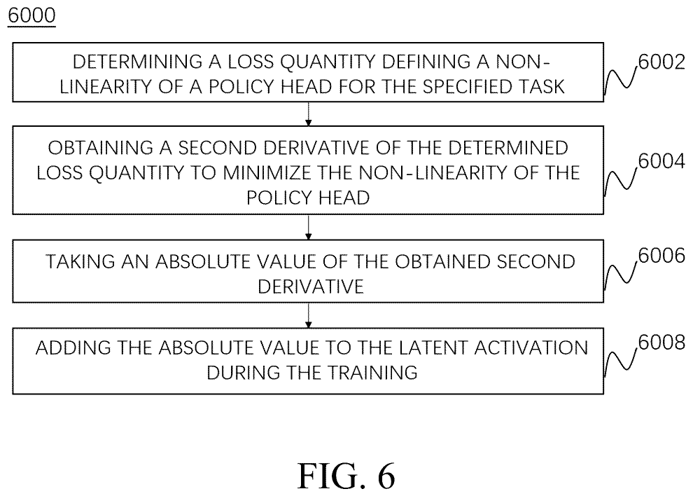

Referring to FIG. 6, in some embodiments, the method 6000 of obtaining an auxiliary loss function is provided. The method 6000 starts at 6002, where a loss quantity defining a non-linearity of a policy head for the specified task is determined. Then, at 6004 a second derivative of the determined loss quantity to minimize the non-linearity of the policy head is obtained. Thereafter, at 6006, an absolute value of the obtained second derivative is taken and at 6008, the absolute value is added to the latent activation during the training to minimize loss and ensure a simple mapping between the predicted action and the actual action output.

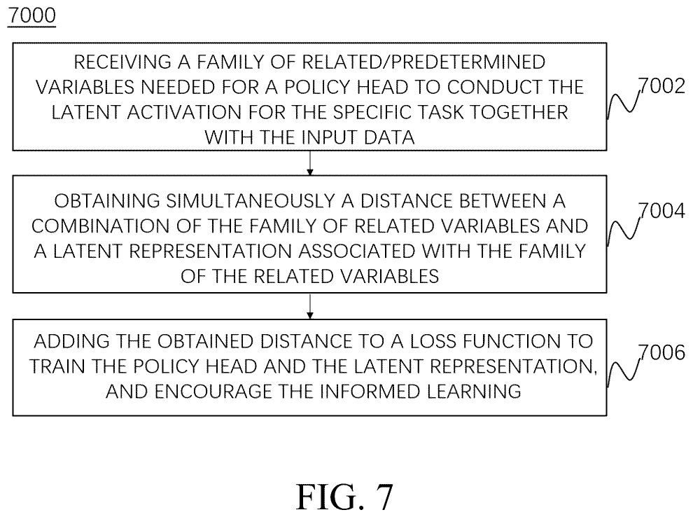

Referring to FIG. 7, in some embodiments, the method 7000 of obtaining an auxiliary loss function via informed learning is provided. The method 7000 starts at 7002, where a family of related/predetermined variables needed for a policy head to conduct the latent activation for the specific task together with the input data is received. Then, at 7004, a distance between a combination of the family of related variables and a latent representation associated with the family of the related variables are obtained simultaneously. Thereafter, at 7006, the obtained distance is added to a loss function to train the policy head and the latent representation, and encourage the informed learning.

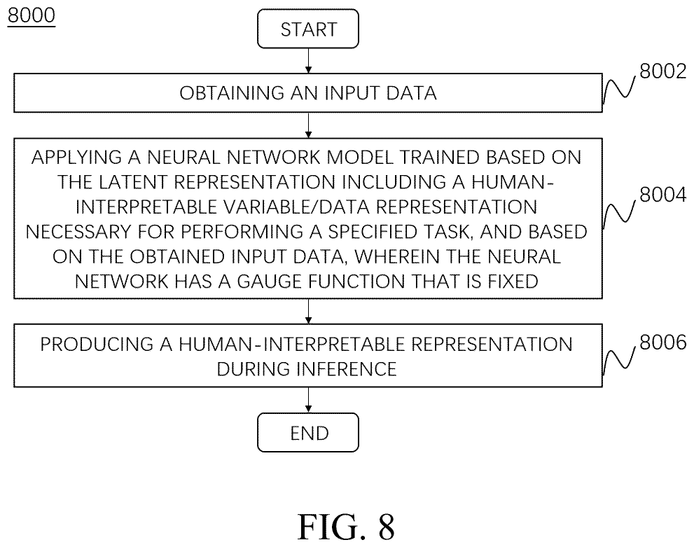

Referring to FIG. 8, in some embodiments, the method 8000 of visualizing a latent representation of a neural network model is provided. The method 8000 starts at 8002, where an input data is obtained. Then, at 8004, a neural network model trained based on the latent representation including a human-interpretable variable/data representation necessary for performing a specified task, and based on the obtained input data is applied. The neural network may have a gauge function that is fixed. Thereafter, at 8006, a human-interpretable representation is produced during inference.

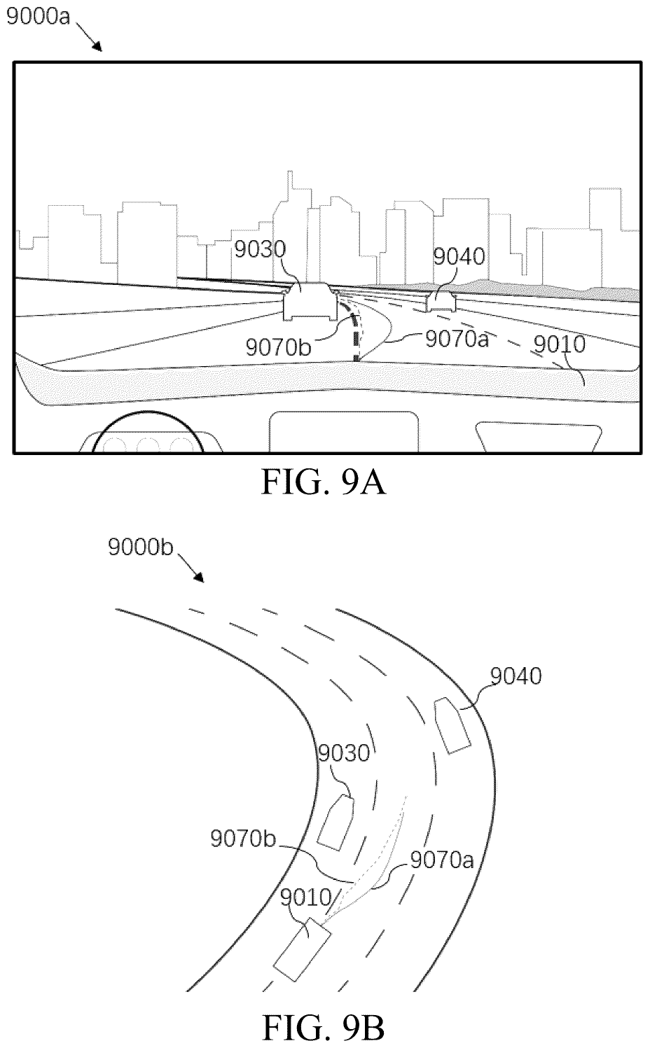

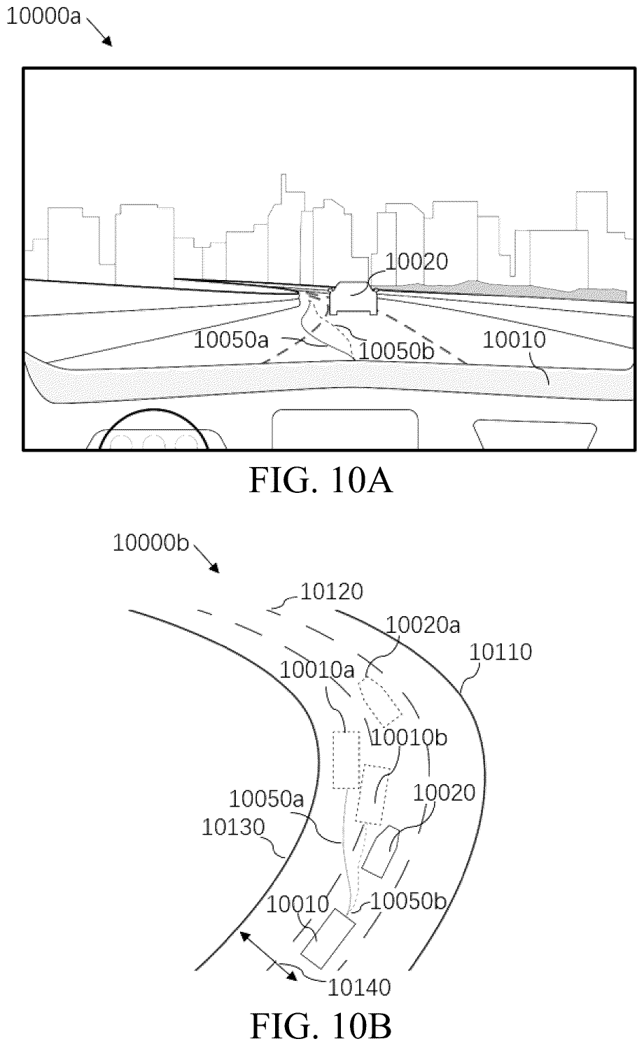

FIGS. 9-10 are illustrations of different examples of operating an autonomous driving system for different tasks.

FIGS. 9A and 9B depict a driver's perspective view 9000a and a top-down view 9000b of a road, respectively, in an exemplary autonomous driving scenario for a lane-centering task, in accordance with some embodiments of the present disclosure. As shown in the figure, from the driver's perspective, the field of view 9000a includes the ego-vehicle 9010, other vehicles 9030 and 9040 driving ahead of the ego-vehicle 9010, the planned trajectory 9070a and 9070b of the ego-vehicle 9010 (represented by a thinner solid line and a thicker dashed line, respectively). Additionally, the field of view 9000a also contains lanes, lane markings, lane boundaries (such as barriers), greenery, and the city skyline, which are not represented by reference numerals for brevity.

The field of view 9000b is a top-down view captured from above the ego-vehicle 9010, looking down at the section of road it is traveling on. It can be observed that the ego-vehicle 9010 is driving along the leftmost first and second lanes, straddling two lanes. The other vehicle 9030 is traveling in the leftmost first lane, while the other vehicle 9040 is traveling in the rightmost first lane. As an example, FIGS. 9A and 9B may relate to a lane-centering task in an autonomous driving scenario. In this task, the control objective of the AI model carried by or associated with the ego-vehicle 9010 (e.g., deployed on the ego-vehicle's autonomous driving system or in the cloud communicating with the ego-vehicle via V2X) is to keep the ego-vehicle within the center of a lane. The planned trajectory 9070a of the ego-vehicle 9010 represents the planned trajectory inferred, based on the current model input during the inference stage, by the AI model trained with auxiliary loss functions. The planned trajectory 9070b represents the planned trajectory inferred, based on the current model input during the inference stage, by the AI model trained without any auxiliary loss functions.

Assuming the two trajectories represent complete solutions for the same task, trajectory 9070a is smoother and shorter compared to trajectory 9070b. This indicates that the AI model performs better in trajectory planning when auxiliary loss functions are introduced, as the planned trajectory ensures a shorter and smoother transition from straddling the lane markings to a safe centered position. On the other hand, trajectory 9070b exhibits more oscillations (which may imply the involvement of braking pedals) and a longer length, with the ego vehicle 9010 moving dangerously close to the other vehicle 9030 and at some distance away from the center of the ego vehicle 9010's lane, indicating inferior basic control performance (such as trajectory planning capabilities) and errors in predictions of trajectory 9070b compared to the scenario with auxiliary loss functions.

FIGS. 10A and 10B depict a driver's perspective view and a top-down view of a road, respectively, in an exemplary autonomous driving scenario for a distance-keeping task, in accordance with some embodiments of the present disclosure. As shown in the figure, from the driver's perspective, the field of view 10000a includes the ego-vehicle 10010, the other vehicle 10020 driving ahead of the ego-vehicle 10010, and the planned trajectories 10050a and 10050b of the ego-vehicle 10010 (represented by a solid line and a dashed line, respectively). Additionally, the field of view 10000a contains unlabeled lanes, lane markings, lane boundaries (such as barriers), greenery, and the city skyline.

The field of view 10000b is a top-down view captured from above the ego-vehicle 10010, looking down at the section of road it is traveling on. It can be observed that the ego-vehicle 10010 is driving right behind the other vehicle 10020, and both are in the leftmost second lane.

As an example, FIGS. 10A and 10B may relate to a distance-keeping task in an autonomous driving scenario. In this task, the control objective of the AI model carried by or associated with the ego-vehicle 10010 (e.g., deployed on the ego-vehicle's autonomous driving system or in the cloud communicating with the ego-vehicle via V2X) is to maintain a safe distance from the vehicle ahead traveling in the same lane. The planned trajectory 10050a of the ego-vehicle 10010 represents the planned trajectory inferred, based on the current model input during the inference stage, by the AI model trained with an auxiliary loss function. The planned trajectory 10050b represents the planned trajectory inferred, based on the current model input during the inference stage, by the AI model trained without any auxiliary loss functions.

Assuming the two trajectories represent complete solutions for the same task, trajectory 10050a is smoother and shorter compared to trajectory 10050b. Moreover, according to trajectory 10050a, in the next time step T+1, the ego-vehicle 10010a has already assertively transitioned to a state where it is in a different lane from the other vehicle 10020a. On the contrary, in trajectory 10050b, in the next time step T+1, the ego-vehicle 10010b is more indecisive and has not yet transitioned to a state where it is in a different lane from the other vehicle 10020a, and the distance between the ego-vehicle 10010b and the other vehicle 10020a has much shortened compared to the relative position between them at the previous time step T, which is in a much more dangerous state not conducive to safe driving. As such, without the auxiliary loss function, the vehicles are more at risk for a collision.

Therefore, it can be seen that the AI model performs better in safety control when auxiliary loss functions are introduced, as the planned trajectory ensures the vehicle can quickly evade adverse situations, such as a shortened safe distance due to the braking of the ahead vehicle (e.g., by smoothly changing lanes). On the other hand, trajectory 10050b, although attempting to guide the ego-vehicle to the adjacent lane, still results in an unsafe situation with further reduction of the car-following distance. Thus, the disclosed auxiliary loss functions not only provide users with an intuitive latent representation of the AI model, but also improve the completion rate of tasks during the actual model inference phase, enhancing the inference performance of the model and improving the user experience.

It should be understood that the examples described with respect to FIGS. 8-10 are merely for illustrative purposes and shall not be construed as limiting the scope of the present disclosure.

In some embodiments, the functions/features described above may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be implemented in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, Flash memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

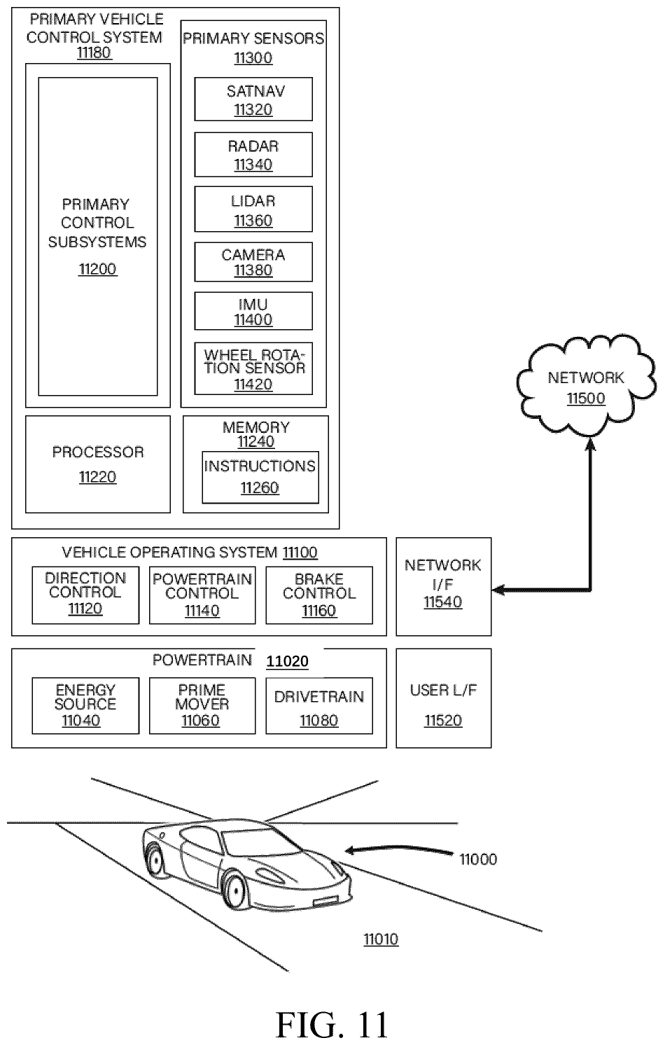

FIG. 11 illustrates an example hardware and software environment for an autonomous vehicle 11000 within which various techniques disclosed herein may be implemented. The vehicle 11000, for example, is shown driving on a road 11010, and the vehicle 11000 may include a powertrain 11020 including a prime mover 11060 powered by an energy source 11040 and capable of providing power to a drivetrain 11080, and a vehicle operating system 11100 including a direction control 11120, a powertrain control 11140 and a brake control 11160. The vehicle 11000 may be implemented as any number of different types of vehicles, including vehicles capable of transporting people and/or cargo, and capable of traveling by land, by sea, by air, underground, undersea and/or in space, and it will be appreciated that the aforementioned components 11020-11160 can vary widely based upon the type of vehicle within which these components are utilized.

For simplicity, the embodiments discussed hereinafter will focus on a wheeled land vehicle such as a car, van, truck, bus, motorcycle, All-Terrain Vehicle (ATV), etc. In such embodiments, the energy source 11040 may include, for example, a fuel system (e.g., providing gasoline, diesel, hydrogen, etc.), a battery system, solar panels, or other renewable energy sources, and/or a fuel cell system. The prime mover 11060 may include one or more electric motors and/or an internal combustion engine (among others). The drivetrain 11080 may include wheels and/or tires along with a transmission and/or any other mechanical drive components suitable for converting the output of the prime mover 11060 into vehicular motion, and one or more brakes configured to controllably stop or slow the vehicle 11000 and direction or steering components suitable for controlling the trajectory of the vehicle 11000 (e.g., a rack and pinion steering linkage enabling one or more wheels of the vehicle 1100 to pivot about a generally vertical axis to vary an angle of the rotational planes of the wheels relative to the longitudinal axis of the vehicle). In some embodiments, combinations of powertrains and energy sources may be used (e.g., in the case of electric/gas hybrid vehicles), and in other embodiments multiple electric motors (e.g., dedicated to individual wheels or axles) may be used as the prime mover 11060. In the case of a hydrogen fuel cell implementation, the prime mover 11060 may include one or more electric motors, and the energy source 11040 may include a fuel cell system powered by hydrogen fuel.

The direction control 11120 may include one or more actuators or sensors for controlling and receiving feedback from the direction or steering components to enable the vehicle 11000 to follow a desired trajectory. The powertrain control 11140 may be configured to control the output of the powertrain 11020, (e.g., to control the output power of the prime mover 11060, to control a gear of a transmission in the drivetrain 11080, etc.), thereby controlling a speed and/or direction of the vehicle 11000. The brake control 11160 may be configured to control one or more brakes that slow or stop the vehicle 11000, (e.g., disk or drum brakes) coupled to the wheels of the vehicle.

Other vehicle types, including but not limited to all-terrain or tracked vehicles, and construction equipment, may utilize different powertrains, drivetrains, energy sources, direction controls, powertrain controls and brake controls. Moreover, in some embodiments, some of the components can be combined, e.g., where directional control of a vehicle is primarily handled by varying an output of one or more prime movers. Therefore, embodiments disclosed herein are not limited to the particular application of the herein-described techniques in an autonomous, wheeled, land vehicle.

In the illustrated embodiment, full or semi-autonomous control over the vehicle 11000 is implemented in a primary vehicle control system 11180, which may include one or more processors 11220 and one or more memories 11240, with each processor 11220 configured to execute program code instructions 11260 stored in the memory 11240. The processors 11220 may include, for example, graphics processing unit(s) (GPU) and/or central processing unit(s) (CPU). The processors 11220 may also include an application-specific integrated circuit (ASICs), other chipsets, logic circuits and/or data processing devices. The memory 11240 may be used to load and store data and/or instructions, for example, for the control system 11180. The memory 11240 may include any combination of suitable volatile memory, for example, read-only memory (ROM), dynamic random-access memory (DRAM), a random-access memory (RAM), non-volatile memory such as a flash memory, a memory card, a storage medium and/or other storage devices. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

Sensors 11300 may include various sensors suitable for collecting information from a vehicle's surrounding environment for use in controlling the operation of the vehicle 11000. For example, the sensors 11300 may include one or more detection and ranging sensors (e.g., a RADAR sensor 11340, a LIDAR sensor 11360, or both), a satellite navigation (SATNAV) sensor 11320, e.g., compatible with any of various satellite navigation systems such as GPS (Global Positioning System), GLONASS (Globalnaya Navigazionnaya Sputnikovaya Sistema, or Global Navigation Satellite System), BeiDou Navigation Satellite System (BDS), Galileo, Compass, etc. The Radio Detection and Ranging (RADAR) 11340 and Light Detection and Ranging (LIDAR) sensors 11360, as well as a digital camera 11380 (which may include various types of image capture devices capable of capturing still and/or video imagery), may be used to sense stationary and moving objects within the immediate vicinity of a vehicle. The camera 11380 can be a monographic or stereographic camera and can record still and/or video images. The SATNAV sensor 11320 can be used to determine the location of the vehicle on the Earth using satellite signals. The sensors 11300 can optionally include an Inertial Measurement Unit (IMU) 11400. The IMU 11400 may include multiple gyroscopes and accelerometers capable of detecting linear and rotational motion of the vehicle 11000 in three directions. One or more other types of sensors, such as wheel rotation sensors/encoders 11420 may be used to monitor the rotation of one or more wheels of vehicle 11000.

In a variety of embodiments, a removable hardware pod is vehicle agnostic and therefore can be mounted on a variety of non-autonomous vehicles including: a car, a bus, a van, a truck, a moped, a tractor trailer, a sports utility vehicle, etc. While autonomous vehicles generally contain a full sensor suite, in many embodiments a removable hardware pod can contain a specialized sensor suite, often with fewer sensors than a full autonomous vehicle sensor suite, which can include: an IMU, 3-D positioning sensors, one or more cameras, a LIDAR unit, etc. Additionally or alternatively, the hardware pod can collect data from the non-autonomous vehicle itself, for example, by integrating with the vehicle's CAN bus to collect a variety of vehicle data including: vehicle speed data, braking data, steering control data, etc. In some embodiments, removable hardware pods can include a computing device which can aggregate data collected by the removable pod sensor suite as well as vehicle data collected from the CAN bus, and upload the collected data to a computing system for further processing (e.g., uploading the data to the cloud). In many embodiments, the computing device in the removable pod can apply a time stamp to each instance of data prior to uploading the data for further processing. Additionally or alternatively, one or more sensors within the removable hardware pod can apply a time stamp to data as it is collected (e.g., a lidar unit can provide its own time stamp). Similarly, a computing device within an autonomous vehicle can apply a time stamp to data collected by the autonomous vehicle's sensor suite, and the time stamped autonomous vehicle data can be uploaded to the computer system for additional processing.

The outputs of sensors 11300 may be provided to a set of primary control subsystems 11200, including, for example, a localization subsystem, a perception subsystem, a planning subsystem, and a control subsystem. The localization subsystem is principally responsible for precisely determining the location and orientation (also sometimes referred to as “pose” or “pose estimation”) of the vehicle 11000 within its surrounding environment, and generally within some frame of reference. In some embodiments, the pose is stored within the memory 11240 as localization data. In some embodiments, a surface model is generated from a high-definition map and stored within the memory 11240 as surface model data. In some embodiments, the detection and ranging sensors store their sensor data in the memory 11240, (e.g., radar data point cloud is stored as radar data). In some embodiments, calibration data is stored in the memory 11240. The perception subsystem is principally responsible for detecting, tracking, and/or identifying objects within the environment surrounding vehicle 11000. A machine learning model, such as the one discussed above in accordance with some embodiments, can be utilized in planning a vehicle trajectory. The control subsystem 11200 is principally responsible for generating suitable control signals for controlling the various controls in the vehicle control system 1118 in order to implement the planned trajectory of the vehicle 11000. Similarly, a machine learning model can be utilized to generate one or more signals to control the autonomous vehicle 11000 to implement the planned trajectory.

It will be appreciated that the collection of components illustrated in FIG. 11 for the vehicle control system 11180 is merely one example. Individual sensors may be omitted in some embodiments. Additionally, or alternatively, in some embodiments, multiple sensors of the same types illustrated in FIG. 11 may be used for redundancy and/or to cover different regions around a vehicle. Moreover, there may be additional sensors of other types beyond those described above to provide actual sensor data related to the operation and environment of the wheeled land vehicle. Likewise, different types and/or combinations of control subsystems may be used in other embodiments. Further, while the primary control subsystems 11200 is illustrated as being separate from the processor 11220 and memory 11240, it will be appreciated that in some embodiments, some or all of the functionality of the primary control subsystems 11200 may be implemented with program code instructions 11260 resident in one or more memories 11240 and executed by one or more processors 11220, and the primary control subsystems 11200 may in some instances be implemented using the same processor(s) and/or memory. Subsystems may be implemented at least in part using various dedicated circuit logic, various processors, various field programmable gate arrays (FPGA), various application-specific integrated circuits (ASIC), various real time controllers, and the like, as noted above, multiple subsystems may utilize circuitry, processors, sensors, and/or other components. Further, the various components in the vehicle control system 1118 may be networked in various manners.

For example, the vehicle 11000 may include one or more network interfaces, e.g., network interface 11540, suitable for communicating with one or more networks 11500 (e.g., a LAN, a WAN, a wireless network, and/or the Internet, among others) to permit the communication of information with other vehicles, computers and/or electronic devices, including, for example, a central service, such as a cloud service, from which the vehicle 11000 receives environmental and other data for use in autonomous control thereof.

In addition, for additional storage, the vehicle 11000 may also include one or more mass storage devices, e.g., a floppy or other removable disk drive, a hard disk drive, a direct access storage device (DASD), an optical drive (e.g., a CD drive, a DVD drive, etc.), a solid-state storage drive (SSD), network attached storage, a storage area network, and/or a tape drive, among others. Furthermore, the vehicle 11000 may include a user interface 11520 to enable the vehicle 1100 to receive a number of inputs from and generate outputs for a user or operator, e.g., one or more displays, touchscreens, voice and/or gesture interfaces, buttons, and other tactile controls, etc. Otherwise, user input may be received via another computer or electronic device, e.g., via an app on a mobile device or via a web interface, e.g., from a remote operator.

Systems and methods are disclosed herein related to object detection and detection confidence. Disclosed approaches may be suitable for autonomous driving, but may also be used for other applications, such as robotics, video analysis, weather forecasting, medical imaging, etc. The present disclosure may be described with respect to an example autonomous vehicle 11000. Although the present disclosure primarily provides examples using autonomous vehicles, other types of devices may be used to implement those various approaches described herein, such as robots, camera systems, weather forecasting devices, medical imaging devices, etc. In addition, these approaches may be used for controlling autonomous vehicles, or for other purposes, such as, without limitation, video surveillance, video or image editing, video or image search or retrieval, object tracking, weather forecasting (e.g., using radar data), and/or medical imaging (e.g., using ultrasound or Magnetic Resonance Imaging (MRI) data).

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit is basically the same. For easy description and simplicity, these working processes will not be detailed.

If the software function unit is realized and used and sold as a product, it may be stored in a readable storage medium in a computer. Based on this understanding, the technical plan proposed by the present disclosure may be essentially or partially realized as the form of a software product. Or one part of the technical plan beneficial to the existing technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a ROM, a RAM, a floppy disk, or other kinds of media capable of storing program codes. While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by people skilled in the art that the embodiments of the disclosure are not limited by what has been particularly shown and described hereinabove. Rather the scope of the embodiments of the disclosure is defined by the appended claims and equivalents thereof.

The previous description of the disclosed embodiments is provided to enable others to make or use the disclosed subject matter. Various modifications to these embodiments will be readily apparent, and the generic principles defined herein may be applied to other embodiments without departing from the spirit or scope of the previous description. Thus, the previous description is not intended to be limited to the embodiments shown herein but is to be accorded the widest scope consistent with the principles and novel features disclosed herein. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.” It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order and are not meant to be limited to the specific order or hierarchy presented.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example. The foregoing method descriptions and the process flow diagrams are provided merely as illustrative examples and are not intended to require or imply that the blocks of various examples must be performed in the order presented. As will be appreciated, the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular. The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. The hardware used to implement the various illustrative logics, logical blocks, modules, and circuits described in connection with the examples disclosed herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

Further Embodiments are listed below.

Embodiment 1. A method of training a neural network model based on a latent representation including a human-interpretable data representation necessary for performing a specified task, including: obtaining an input data; training the neural network model based on the obtained input data; fixing a gauge function by applying an auxiliary loss function on a latent activation for the specified task, during the training of the neural network model to minimize redundancy; and producing a human-interpretable representation of the latent representation of the neural network model, based on the application of the auxiliary loss function on the latent representation.

Embodiment 2. The method of Embodiment 1, where the auxiliary loss function is obtained by: determining a loss quantity defining a non-linearity of a policy head for the specified task; obtaining a second derivative of the determined loss quantity to minimize the non-linearity of the policy head; taking an absolute value of the obtained second derivative; and adding the absolute value to the latent activation during the training.

Embodiment 3. The method of any of Embodiments 1-2, where the auxiliary loss function is obtained via informed learning by: receiving a family of related predetermined variables needed for a policy head to conduct the latent activation for the specific task together with the input data, obtaining simultaneously a distance between a combination of the family of related predetermined variables and a latent representation associated with the family of the related predetermined variables, and adding the obtained distance to a loss function to train the policy head and the latent representation, and encourage the informed learning.

Embodiment 4. The method of any of Embodiments 1-3, where the training of the policy head and the latent representation are performed simultaneously during the training of the neural network.

Embodiment 5. The method of any of Embodiments 1-4, where the specified task includes positioning a vehicle at a center of a lane on which the vehicle travels.

Embodiment 6. The method of any of Embodiments 1-5, further including extracting a relevant quantity from the input data, the relevant quantity including a boundary line of a lane on which a vehicle travels, a distance from the vehicle to the boundary line, a curvature of the boundary line, or information allowing for the vehicle to stay at a center of the lane.

Embodiment 7. The method of any of Embodiments 1-6, where the auxiliary loss function is determined by further receiving a predefined policy head with the received family of related predetermined variables.

Embodiment 8. The method of any of Embodiments 1-7, where the predetermined policy head and the received variables are shared amongst neurons within the latent representation.

Embodiment 9. A method of visualizing a latent representation of a neural network model, including: obtaining an input data; applying a neural network model trained based on the latent representation including a human-interpretable variable/data representation necessary for performing a specified task, and based on the obtained input data, wherein the neural network has a gauge function that is fixed; producing a human-interpretable representation during inference.

Embodiment 10. The method of Embodiment 9, where the neural network model is trained by visualizing the latent representation that includes a human-interpretable representation necessary for performing a specified task.

Embodiment 11. The method of any of Embodiments 9-10, where the latent representation is compared to a second latent representation during inference, and a measurement of how close a vehicle is to a center of a lane is determined.

Embodiment 12. A non-transitory computer-readable storage medium having stored thereon instructions that, when executed by one or more processors, cause the one or more processors to execute operations including: obtaining an input data; training the neural network model based on the obtained input data; fixing a gauge function by applying an auxiliary loss function on a latent activation for the specified task, during the training of the neural network model to minimize redundancy; and producing a human-interpretable representation of the latent representation of the neural network model, based on the application of the auxiliary loss function on the latent representation.

Embodiment 13. The non-transitory computer-readable storage medium of Embodiment 12, where the auxiliary loss function is obtained by: determining a loss quantity defining a non-linearity of a policy head for the specified task; obtaining a second derivative of the determined loss quantity to minimize the non-linearity of the policy head; taking an absolute value of the obtained second derivative; and adding the absolute value to the latent activation during the training.

Embodiment 14. The non-transitory computer-readable storage medium of Embodiments 12-13, where the auxiliary loss function is obtained via informed learning by: receiving a family of related predetermined variables needed for a policy head to conduct the latent activation for the specific task together with the input data, obtaining simultaneously a distance between a combination of the family of related variables and a latent representation associated with the family of the related variables, and adding the obtained distance to a loss function to train the policy head and the latent representation, and encourage the informed learning.

Embodiment 15. The non-transitory computer-readable storage medium of Embodiments 12-14, where the training of the policy head and the latent representation are performed simultaneously during the training of the neural network.

Embodiment 16. The non-transitory computer-readable storage medium of Embodiments 12-15, where the specified task includes positioning a vehicle at a center of a lane on which the vehicle travels.

Embodiment 17. The non-transitory computer-readable storage medium of Embodiments 12-16, where the operations further including extracting a relevant quantity from the input data, the relevant quantity including a boundary line of a lane on which a vehicle travels, a distance from the vehicle to the boundary line, a curvature of the boundary line, or information allowing for the vehicle to stay at a center of the lane.

Embodiment 18. The non-transitory computer-readable storage medium of Embodiments 10-17, where the auxiliary loss function is determined by further receiving a predefined policy head with the received family of related predetermined variables.

Embodiment 19. The non-transitory computer-readable storage medium of Embodiments 10-17, where the predetermined policy head and the received variables are shared amongst neurons within the latent representation.

Embodiment 20. A computer-implemented system including one or more memory devices that store instructions that, when executed by the one or more processors, cause the one or more processors to execute the method of any of Embodiments 1-11.

What is claimed is:

1. A method of training a neural network model based on a latent representation including a human-interpretable data representation necessary for performing a specified task, comprising:
obtaining an input data;
training the neural network model based on the obtained input data;
fixing a gauge function by applying an auxiliary loss function on a latent activation for the specified task, during the training of the neural network model to minimize redundancy; and
producing a human-interpretable representation of the latent representation of the neural network model, based on the application of the auxiliary loss function on the latent representation.

2. The method of claim 1, wherein the auxiliary loss function obtained by:
determining a loss quantity defining a non-linearity of a policy head for the specified task;
obtaining a second derivative of the determined loss quantity to minimize the non-linearity of the policy head;
taking an absolute value of the obtained second derivative; and
adding the absolute value to the latent activation during the training.

3. The method of claim 1, wherein the auxiliary loss function is obtained via informed learning by:
receiving a family of related predetermined variables needed for a policy head to conduct the latent activation for the specific task together with the input data,
obtaining simultaneously a distance between a combination of the family of related predetermined variables and a latent representation associated with the family of the related predetermined variables, and
adding the obtained distance to a loss function to train the policy head and the latent representation, and encourage the informed learning.

4. The method of claim 3, wherein the training of the policy head and the latent representation are performed simultaneously during the training of the neural network.

5. The method of claim 1, wherein the specified task includes positioning a vehicle at a center of a lane on which the vehicle travels.

6. The method of claim 2, further comprising extracting a relevant quantity from the input data, the relevant quantity including:
a boundary line of a lane on which a vehicle travels,
a distance from the vehicle to the boundary line,
a curvature of the boundary line, or
information allowing for the vehicle to stay at a center of the lane.

7. The method of claim 3, wherein the auxiliary loss function is determined by:
further receiving a predefined policy head with the received family of related predetermined variables.

8. The method of claim 6, wherein the predetermined policy head and the received variables are shared amongst neurons within the latent representation.

9. A method of visualizing a latent representation of a neural network model, comprising:
obtaining an input data;
applying a neural network model trained based on the latent representation including a human-interpretable data representation necessary for performing a specified task, and based on the obtained input data, wherein the neural network has a gauge function that is fixed;
producing a human-interpretable representation during inference.

10. The method of claim 9, wherein the neural network model is trained by visualizing the latent representation that includes a human-interpretable representation necessary for performing a specified task.

11. The method of claim 9, wherein the latent representation is compared to a second latent representation during inference, and a measurement of how close a vehicle is to a center of a lane is determined.

12. A non-transitory computer-readable storage medium having stored thereon instructions that, when executed by one or more processors, cause the one or more processors to execute operations comprising:
obtaining an input data;
training the neural network model based on the obtained input data;
fixing a gauge function by applying an auxiliary loss function on a latent activation for the specified task, during the training of the neural network model to minimize redundancy; and
producing a human-interpretable representation of the latent representation of the neural network model, based on the application of the auxiliary loss function on the latent representation.

13. The non-transitory computer-readable storage medium of claim 12, wherein the auxiliary loss function obtained by:
determining a loss quantity defining a non-linearity of a policy head for the specified task;
obtaining a second derivative of the determined loss quantity to minimize the non-linearity of the policy head;
taking an absolute value of the obtained second derivative; and
adding the absolute value to the latent activation during the training.

14. The non-transitory computer-readable storage medium of claim 12, wherein the auxiliary loss function is obtained via informed learning by:
receiving a family of related predetermined variables needed for a policy head to conduct the latent activation for the specific task together with the input data,
obtaining simultaneously a distance between a combination of the family of related variables and a latent representation associated with the family of the related variables, and
adding the obtained distance to a loss function to train the policy head and the latent representation, and encourage the informed learning.

15. The non-transitory computer-readable storage medium of claim 14, wherein the training of the policy head and the latent representation are performed simultaneously during the training of the neural network.

16. The non-transitory computer-readable storage medium of claim 12, wherein the specified task includes positioning a vehicle at a center of a lane on which the vehicle travels.

17. The non-transitory computer-readable storage medium of claim 13, further comprising extracting a relevant quantity from the input data, the relevant quantity including:
a boundary line of a lane on which a vehicle travels,
a distance from the vehicle to the boundary line,
a curvature of the boundary line, or
information allowing for the vehicle to stay at a center of the lane.

18. The non-transitory computer-readable storage medium of claim 14, wherein the auxiliary loss function is determined by:
further receiving a predefined policy head with the received family of related predetermined variables.

19. The non-transitory computer-readable storage medium of claim 17, wherein the predetermined policy head and the received variables are shared amongst neurons within the latent representation.

20. A computer-implemented system comprising: one or more memory devices that store instructions that, when executed by the one or more processors, cause the one or more processors to execute the method of claim 1.
